(19) United States
(12) Patent Application Publication
(10) Pub. No.: US 2023/0397046 A1
(43) Pub. Date: Dec. 7, 2023

(54) DYNAMIC MVNO TRAFFIC OFFLOADING

(71) Applicant: CHARTER COMMUNICATIONS OPERATING, LLC, St. Louis, MO (US)

(72) Inventors: Yildirim SAHIN, Englewood, CO (US); Curt WONG, Bellevue, WA (US); Umamaheswar Achari KAKINADA, Greenwood Village, CO (US)

(73) Assignee: CHARTER COMMUNICATIONS OPERATING, LLC, St. Louis, MO (US)

(21) Appl. No.: 17/832,924

(22) Filed: Jun. 6, 2022

(51) Int. Cl. H04W 28/08; H04W 28/02

(52) U.S. Cl. CPC H04W 28/0804; H04W 28/0236

(57) ABSTRACT

Various embodiments comprise systems, methods, architectures, mechanisms and apparatus for managing UE migration or offloading from mobile network operators (MNO) cells to mobile virtual network operators (MVNO) cells (optionally access points) in a dual-network deployment use case by identifying and communicating one or more dynamic traffic offload policies to UE(s) based information provided by MVNO subscriber UEs and/or information generated by the network itself. In this manner, the MVNO network operator may control an amount of traffic in the MVNO small cell network while avoiding or at least reducing negative end-user experience. In various embodiments, the UE offloaded from the MNO to the MVNO may be roaming UE associated with a different MVNO.

### FIELD OF THE DISCLOSURE

The present disclosure generally relates to wireless communications systems and related networks, and more particularly to user equipment migration between network services providers.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Mobile network operators (MNOs) typically own and manage significant telecommunications infrastructure used to provide wireless services via cellular coverage for users of their cellular/mobile network services. MNOs have deployed universal mobile telecommunications system (UMTS) nodes and/or high-speed packet access (HSPA) nodes to provide coverage to the users of their network. These deployments have been augmented by the deployment of third generation partnership project (3GPP) long term evolution (LTE) coverage (e.g., 4G/LTE) to increase network performance, provide new services and so on. Deployment of 3GPP 5G New Radio (5G NR) and related technologies provides further improvements in network performance as well new or improved network services.

Mobile virtual network operators (MVNOs) may own little or none of the telecommunications infrastructure used to provide wireless services for their users. For example, network operators such as Multiple-System Operators (MSOs) may operate as MVNOs via a dual-network deployment model wherein the telecommunications infrastructure of the partner MNO (which typically has nation-wide coverage) is primarily used to offer wireless services to MVNO customers while the wireless (e.g. Wi-Fi) and the MVNO telecommunications infrastructure of the MSO (which may have limited coverage, e.g., small cell network deployment at shopping centers) is used to augment and/or offload certain wireless services (e.g., internet traffic) offered to MVNO customers.

In such a “dual-network” deployment model, individual MVNO-deployed cells (base stations, eNBs, gNBs, etc.) such as part of a small cell network might face capacity problems including low or insufficient capacity to handle the necessary number of user equipment (UE) attachments and/or services delivery thereto. That is, the capacity of the deployed MVNO cells may not be able to handle the amount of traffic from the UEs being offloaded from the MNO network to the MVNO network.

MVNO cell capacity issues may arise due to several factors, such as an insufficient number of MVNO small cells in an area, insufficient amount of spectrum availability to the deployed MVNO cells, a reduction in spectrum availability such as for Citizens Broadband Radio Service (CBRS) spectrum e.g., due to pre-emption by priority or incumbent users of the CBRS spectrum, and so on. By contrast, MNO cell capacity is less likely to suffer from similar problems because of MNO infrastructure using licensed spectrum bands and designing the network to have sufficient amount of spectrum to meet the anticipated traffic load.

Due to such potential capacity concerns in the MVNO small cell network, some UEs may experience degraded application performance (e.g., increased delay, lower throughput) once the network services traffic supporting the UE applications is offloaded from the MNO network to the MVNO small cell network.

### SUMMARY

Various deficiencies in the prior art are addressed by systems, methods, and apparatus for managing UE migration or offloading from mobile network operators (MNO) cells to mobile virtual network operators (MVNO) cells (optionally access points) in a dual-network deployment use case by identifying and communicating one or more dynamic traffic offload policies to UE(s) based information provided by MVNO subscriber UEs and/or information generated by the network itself In this manner, the MVNO network operator may control an amount of traffic in the MVNO small cell network while avoiding or at least reducing negative end-user experience. In various embodiments, the UE offloaded from the MNO to the MVNO may be roaming UE associated with a different MVNO (i.e., an MVNO-x).

One embodiment comprises a method of managing Dual SIM Dual Standby (DSDS) user equipment (UE) configured to communicate with each of a first and second network, comprising: at a connection manager server (CMS) of the second network, receiving a traffic offload policy associated with an identified cell or group of cells of the second network; at the CMS, determining each of at least one UE proximate any of the identified cell or group of cells of the second network; and transmitting traffic offload rules toward the determined each of at least one UE proximate any of the identified cell or group of cells of the second network; wherein each traffic offload rule is configured to cause a receiving UE to offload to a proximate identified cell in the second network for an effective time period an amount of traffic defined by the traffic offload rule.

Additional objects, advantages, and novel features of the invention will be set forth in part in the description which follows, and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a simplified network services architecture suitable for use in various embodiments;

FIG. 2 depicts a flow diagram of a UE registration and policy acceptance method according to an embodiment;

FIG. 3 depicts a flow diagram of a network controlled MNO to MVNO offloading method according to an embodiment;

FIG. 4 depicts a flow diagram of a CM/UE-controlled MNO to MVNO offloading method according to an embodiment; and

FIG. 5 graphically depicts signaling between MVNO and MVNO-x networks useful in understanding various embodiments.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Various embodiments provide for managing UE migration or offloading from mobile network operators (MNO) cells to mobile virtual network operators (MVNO) cells (optionally access points) in a dual-network deployment use case by identifying and communicating one or more dynamic traffic offload policies to UE(s) based information provided by MVNO subscriber UEs and/or information generated by the network itself. In this manner, the MVNO network operator may control an amount of traffic in the MVNO small cell network while avoiding or at least reducing negative end-user experience.

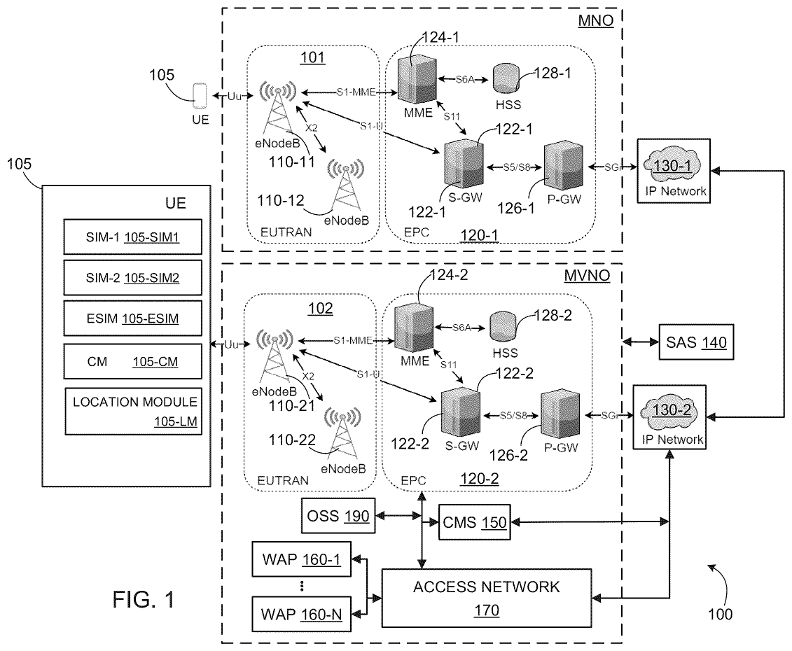

FIG. 1 depicts a simplified network services architecture suitable for use in various embodiments. Specifically, FIG. 1 depicts a first network (e.g., an MNO network) and a second network (e.g., an MVNO network), each network comprising respective deployed networking or telecommunications infrastructure configured to provide network services (e.g., voice, streaming media, data upload/download etc.) services to respective subscribers/users. While various embodiments are depicted and described herein within the context of an MVNO network using infrastructure of an MNO network for service backup purposes, the first and second networks do not need to be in an MVNO/MNO arrangement. For example, the second network may be a private network owned and/or operated by an MNO that a UE, which has subscriptions to and capable of connecting to both the first network (owned by the same MNO) and the second networks, in the overlapping network coverage area of both networks, the UE may be configured to prioritize the usage of the second network over the first network for some services.

Therefore, some of the embodiments provide for the offloading of UE traffic from a MNO network (first network) to a MVNO network (second network). Other embodiments provide for the offloading of UE traffic from a MNO network (first network) to a MVNO network (second network), where the UE is subscribed to a MVNO-x network (third network) and roaming with respect to the MVNO (second network). The MVNO and MVNO-x networks may be commonly owned or owned by different Operators.

The MNO network is configured to provide network services to respective subscribers/users via user equipment (UE) 105 configured to communicate with MNO nodes (e.g., nodes 110-11, 110-12, and so on) of, illustratively, a public land mobile network (PLMN) such as a E-UTRAN (LTE access network) connected to a core network, illustratively an evolved packet core (EPC) 120-1, which provides network services from/to external networks 130-1.

As depicted in FIG. 1, the MNO network comprises nodes 110-1x comprising cellular network base stations, eNodeBs (eNBs), 4G/5G repeaters, and similar types of provider equipment or radio nodes (e.g., gNBs) derived therefrom. Each node 110-1x provides network services to UE 105 via respective radio bearer (channels/resources) which are managed by various Radio Resource Management functions, such as Radio Bearer Control, Radio Admission Control, Connection Mobility Control, Scheduling of UEs in both uplink and downlink and so on. As depicted, the MNO nodes 110-1x communicate with a core network comprising an evolved packet core (EPC) 120-1, comprising, a Serving Gateway (SGW) 122-1, a Mobility Management Entity (MME) 124-1, a Packet Data Network (PDN) Gateway (PGW) 126-1, a Home Subscriber Server (HSS) 128-1, other network elements (not shown) operative to provide the various functions necessary to enable UE authentication, network services, application services and the like as is known.

The MVNO network is configured to provide network services to respective subscribers/users via UE 105 configured to communicate with MVNO nodes (e.g., nodes 110-21, 110-22, and so on) of, illustratively, a E-UTRAN (LTE access network) connected to a core network, illustratively an evolved packet core (EPC) 120-2 and/or a plurality of wireless access points (WAPs) 160-1, 160-2 and so on (collectively WAPs 160) connected to one or more access networks 170, wherein the core network 120-2 and access network(s) 170 provide network services from/to external networks 130-2. The WAPs 160-x and associated Access Network 170 may be implemented as part of the MVNO network as depicted in FIG. 1 and described herein. Alternatively or in addition, the WAPs 160-x and associated Access Network 170 may be implemented as a standalone network that does not belong to MVNO. When part of the MVNO network, these nodes (160-x and 170) may be integrated into the EPC 120 (or 5GC) as a non-3GPP access points such as specified in the relevant 3GPP specifications.

The MVNO network may comprise a small cell network deployed as a private network (e.g. an Standalone Non-Public Network (SNPN)), or as a PLMN that allows access only to its subscribers and possibly to subscribers of another MVNO operator who may have similar traffic offload interests (i.e., the MVNO may have business roaming agreements with other MVNOs having small cell network deployments so as to extend their respective small cell network coverage to different geographical areas). As depicted, the MNO and MVNO networks operate independently without having any 3GPP roaming interfaces configured between them, though other configurations in which network management functions are more tightly coordinated are also contemplated.

As depicted in FIG. 1, the MVNO network comprises nodes 110-2x comprising macrocells, small cells, microcells and the like such as eNodeBs (eNBs) and similar types of provider equipment or radio nodes (e.g., gNBs) derived therefrom. Each node 110-2x provides network services to UE 105 via respective radio bearer (channels/resources) which are managed by various Radio Resource Management functions, such as Radio Bearer Control, Radio Admission Control, Connection Mobility Control, Scheduling of UEs in both uplink and downlink and so on. As depicted, the MVNO nodes 110-2x communicate with a core network comprising an evolved packet core (EPC) 120-2, comprising, a Serving Gateway (SGW) 122-2, a Mobility Management Entity (MME) 124-2, a Packet Data Network (PDN) Gateway (PGW) 126-2, a Home Subscriber Server (HSS) 128-2, other network elements (not shown) operative to provide the various functions necessary to enable UE authentication, network services, application services and the like.

In some embodiments, the MVNO network comprises a converged network configured to enable UE to access subscriber services available network nodes 110-2x or via any of a plurality of wireless access points (WAPs) 160. The WAPs 160 of the MVNO converged network may comprise IEEE 802.1 lxx wireless access points at a home, business or other location configured to communicate with UE 105 and with an access network 170. In various embodiments, the MVNO utilizes numerous such access points distributed over a “coverage footprint” to provide network services to mobile devices such as the UE 105 discussed herein.

In various embodiments, the MVNO network may include network nodes 110-2x (optionally WAPs 160) configured to utilize unlicensed spectrum in addition to, or instead of, licensed spectrum. That is, the MVNO network may include network nodes 110-2x or APs 160 utilizing unlicensed or shared spectrum, illustratively as Citizens Broadband Radio Service Devices (CBSDs) utilizing spectrum associated with the Citizens Broadband Radio Service (CBRS), which is currently configured as a 150 MHz band between 3.55 GHz and 3.70 GHz. Spectrum access is granted to CBSDs, such as base stations, eNBs, gNBs and the like via a Spectrum Access System (SAS) 140 operating in accordance with, illustratively, a CBSD-SAS registration and spectrum grant process such as that described in the WINNF-TS-0016 standards document.

It is further noted that different types of deployed MNO and MVNO infrastructure may be used within the context of the various embodiments, such as via differing types of nodes 110 supported by 4G/LTE, 5G New Radio, and/or other types of core networks 120, differing types of WAPs 160, and so on.

As depicted in FIG. 1, the UE 105 may comprise any type of wireless device configured for use in accordance with the various embodiments, such as user terminals (e.g., mobile phones, laptops, tablets and the like), fixed wireless access devices (e.g., set top boxes, digital video recorders, stationary computing devices and the like), Internet of Things (IoT) devices (e.g., sensors, monitoring devices, alarm system devices and the like), and/or other wireless devices. The UE 105 may include UE associated with mobile network protocols (e.g., 3G/4G/LTE/5G), WiFi protocols (e.g., 802.1 lax), and the like.

As depicted in FIG. 1, the UE 105 comprise a first subscriber identity module (SIM, also known as universal integrated circuit card (UICC)) 105-SIM1 and at least one of a second SIM 105-SIM2 and an embedded SIM (eSIM, also known as embedded UICC (eUICC)) 105-ESIM, wherein a first SIM (or eSIM) is associated with a first subscription tied to the MNO network, and a second SIM (or eSIM) is associated with a second subscription tied to the MVNO small cell network. If access to the MVNO network and/or the MNO network does not require a SIM-based subscription, the associated subscription credentials may be stored in a secure location in the UE instead of SIM/eSIM. The UE 105 may comprise enhanced dual-subscription devices like Dual SIM Dual Standby (DSDS) UE that performs various functions in accordance with the embodiments, such as will be described below. Further, a location module 105-LM such as a GPS receiver may also be provided in the UE 105 such that local UE location information may be developed. Various other UE functions are also provided within the UE, though such functions are not discussed in detail herein.

As depicted in FIG. 1, the UE 105 comprise a connection manager (CM) 105-CM configured to interact with a Connection Manager Server (CMS) 150 at the MVNO network so as to perform various functions in accordance with the embodiments, such as will be described below. Communication between a CM 105-CM of a UE 105 and the CMS 150 of the MVNO network may be enabled using internet protocol (IP) or other means such as via the MVNO network, the MNO network, or some other network (e.g., WiFi network) or communication means available to the corresponding UE 105.

Generally speaking, the CM 105-CM and CMS 150 operate to assist/control a UE 105 in selecting an appropriate network (e.g., the MNO network when the MVNO network is not available, or the MVNO network when it becomes available) to transmit and receive user/application data. It will be noted that while an enhanced DSDS UE 105 with CM 105-CM enables internet data traffic to be transferred through either of the MNO and MVNO networks, the end-user of the DSDS UE 105 (i.e., the user of UE 105) may only see connectivity to one network advertised in the device display, such as the MNO network. In other words there may be no indication regarding MVNO small cell network to the end-user, and the end-user may not necessarily be made aware whether MVNO small cell network being utilized at any given time.

The CMS 150 provides a policy to a CM 105-CM. Based on the provided policy, the UE 105 will try to carry certain traffic types on the MVNO small cell network when both MNO and MVNO networks are available. Due to radio/modem connectivity capabilities of the UE 105 (e.g., dual-standby), at any given time the UE 105 may only be able to keep one active Radio Resource Control (RRC) state (e.g., RRC-ACTIVE) to one of the networks while the radio connectivity to other network is in an inactive state (e.g., RRC-IDLE).

It is noted that the CMS 150 may have connectivity to various other network elements (e.g., Business Support System (BSS)/OSS 190, or other provider equipment entity performing the functions described herein with respect to the various embodiments) in the MVNO network to authenticate and authorize the CM 105-CM; and also for constructing and/or sharing any information that has been exchanged between the CM 105-CM and the CMS 150.

An Operation Support System (OSS) 190 is configured to perform various support management functions, such as network inventory, service provisioning, network configuration and fault management. The OSS 190 is operatively coupled, directly or indirectly, to the CMS 150, the EPC core 120 (and therethrough to the MVNO radio access network (RAN) 102 formed by the small cells 110-2x of the MVNO network), and the access network 170 (and therethrough to the RAN formed by the WAPs 160).

In accordance with a first or default traffic offload policy according to some embodiments, when a UE 105 detects the availability of a small cell 110-2x in the MVNO network, the UE 105 selects to connect to the detected small cell 110-2x in accordance with the relevant 3GPP specifications (e.g., 3GPP TS 23.122, 3GPP TS 36.304, 3GPP TS 38.304, etc.) and performs relevant 3GPP procedures to make use of the MVNO network. That is, if an MVNO small cell is available, as a default traffic offload policy, a UE 105 may be configured to always prefer using the MVNO network for certain traffic types (e.g., internet traffic) instead of using the MNO network unless the UE has to be connected to the MNO network (e.g., due to limitations its radio network capabilities) to carry certain other types of traffic (e.g., IP Multimedia Subsystem (IMS) voice traffic), which can only be supported by the MNO network. For example, when a DSDS capable UE is in use of IMS voice service on the MNO network, internet traffic is also carried on the same MNO network.

In accordance with a first or default traffic offload policy according to some embodiments, when a UE 105 detects the availability of a WAP 160 in the MVNO network, the UE 105 attaches to the detected WAP 160. That is, the exemplary second CM 105-CMICMS 150 traffic offload policy prioritizes the offloading of UE traffic from the MNO network to the MVNO network, and further from small cells 110-2x in the MVNO network to WAPs 160 in the MVNO network.

Various embodiments are directed to methods for identifying and communicating dynamic traffic offload policies to UE(s) in dual-network deployment use cases as described herein. The embodiments contemplate each of a network-controlled solution, and a CM/UE-controlled solution.

Various elements or portions thereof depicted in FIG. 1 and having functions described herein are implemented at least in part as computing devices having communications capabilities, including for example the UE 105, nodes 110, SAS 140, CMS 150, WAPs 160 and various portions of the core networks 120. These elements or portions thereof have computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

As discussed herein various embodiments enable an exchange of information pertaining to evolving network conditions between a connection manager instantiated at a device (e.g., UE) and a connection manager server, such as configured for assisting a serving MVNO to make various offloading decisions. In different embodiments, these decisions may be made in a network controlled manner and/or a CM/UE controlled manner. Disclosed techniques provide for a device subscribed to a given MVNO while under coverage of a different partner MVNO, to use the network services to offload data in various methods described herein. Information exchanged by MVNOs and/or portions thereof may be used to make offload decisions in both CM/UE- and/or network-controlled manner in accordance with operator policies and under various scenarios within the network and/or usage of data within the network.

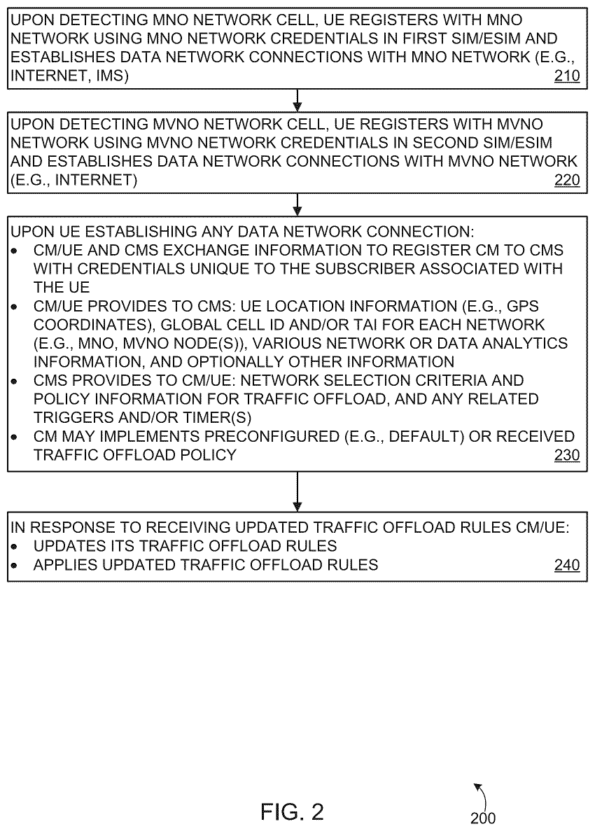

FIG. 2 depicts a flow diagram of a UE registration and policy acceptance method according to an embodiment. Specifically, the method 200 of FIG. 2 depicts various steps taken by UE 105 such as depicted above with respect to FIG. 1.

It is noted that every 3GPP EUTRA cell is identified by a Cell Global Identifier (CGI) (e.g., ECGI (E-UTRA Cell Global Identification) as per 3GPP TS 23.003) consisting of an MCC (Mobile Country Code), an MNC (Mobile Network Code), and a Cell Identifier. Similarly, every 3GPP 5G/NR cell is identified by a CGI (e.g., NCGI (NR Cell Global Identity) as per 3GPP TS 23.003) consisting of an MCC, an MNC, and a Cell Identifier. The Cell Identifier has a length of 28 bits for EUTRA and 36 bits for 5G/NR. Every 3GPP EUTRA cell and 3GPP 5G/NR cell is associated with a Tracking Area Identity (TAI), consisting of the MCC, MNC, and a Tracking Area Code (TAC). The TAC has a length of 16 bits for EUTRA and 24 bits for 5G/NR. The CGI and TAI of the 3GPP EUTRA and 5G/NR cells are broadcast via System Information Block 1 (SIB1) messages to UE 105 to enable cell selection or reselection thereat. In the case of 5G SNPN, a Network Identifier (NID) is also broadcast along with the MCC and MNC in the SIB1 of the NR cell.

Referring to FIG. 2, after power up, the UE executes steps 210 and 220 in any order. At step 210, upon detecting a MNO network cell, the UE registers with the MNO network using MNO network credentials in a first SIM/eSIM and establishes data network connections with MNO network (e.g., internet, IMS). Similarly, at step 220, upon detecting a MVNO network cell, UE registers with the MVNO network using MVNO network credentials in a second SIM/eSIM and establishes data network connections with MVNO network (e.g., internet).

At step 230, upon the UE establishing any data network connection (or waiting for a particular connection such as to the MVNO or MNO network), the CM 105-CM of the UE and CMS 150 exchange information to register the CM 105-CM of the UE to the CMS 150 with credentials unique to the subscriber associated with the UE 105. For example, the 105CM of the UE provides to CMS 150: UE location information (in the form of Global Positioning System (GPS) location such as provided by the location module 105-LM), global cell id and/or TAI for each network (i.e., MNO, MVNO network node(s)), various network or data analytics information, and optionally other information. The CMS 150 provides to the CM 105-CM of the UE network selection criteria and policy information for traffic offload, and any related triggers and/or timer(s). The traffic offload policy information may contain a default traffic offload policy, which may also be preconfigured in the CM 105-CM of the UE.

Specifically, when the UE is powered on, after having established IP connectivity, the CM 105-CM of the UE 105 performs registration function with respect to the CMS 150 via credentials unique to the subscriber. Once the connectivity between the CM 105-CM and the CMS 150 is established, as needed, information like UE location, network (i.e., MNO or MVNO) selection criteria and policy information for traffic offload, and various network and data analytics information, etc. may be exchanged between the CM 105-CM and the CMS 150.

Based on the policy provided by the CMS 150 to the CM, the UE will be configured to try to carry certain traffic types on the MVNO small cell network when both MNO and MVNO networks are available. Due to radio/modem connectivity capabilities of the UE (e.g., dual-standby), at any given time the UE may only be able to keep one active RRC state (i.e. RRC-ACTIVE) to one of the networks while the radio connectivity to other network is inactive state (i.e. RRC-IDLE). The UE, if the UE and the network(s) support, may utilize the MUSIM (Multi-USIM) features standardized in 3GPP Rel-17 when switching between the MNO and the MVNO networks.

The UE 105 detects the availability of a small cell in the MVNO network and selects to connect it based on relevant 3GPP specifications (e.g., 3GPP TS 23.122, 3GPP TS 36.304, 3GPP TS 38.304) and performs relevant 3GPP procedures to make use of the MVNO network. As a default traffic offload policy on the CM/UE, if an MVNO small cell is available, the UE may be configured to prefer using the MVNO network for certain traffic types (internet traffic) instead of using the MNO network unless the UE has to be connected to the MNO network (due to limitations its radio network capabilities) to carry certain other types of traffic (e.g., IMS voice), which can only be supported by the MNO network. For example, when a DSDS capable UE is in use of IMS voice service on the MNO network, internet traffic is also carried on the same MNO network.

At step 240, in response to receiving updated traffic offload rules, the CM 105-CM of the UE 105 updates its traffic offload rules and applies the updated traffic offload rules.

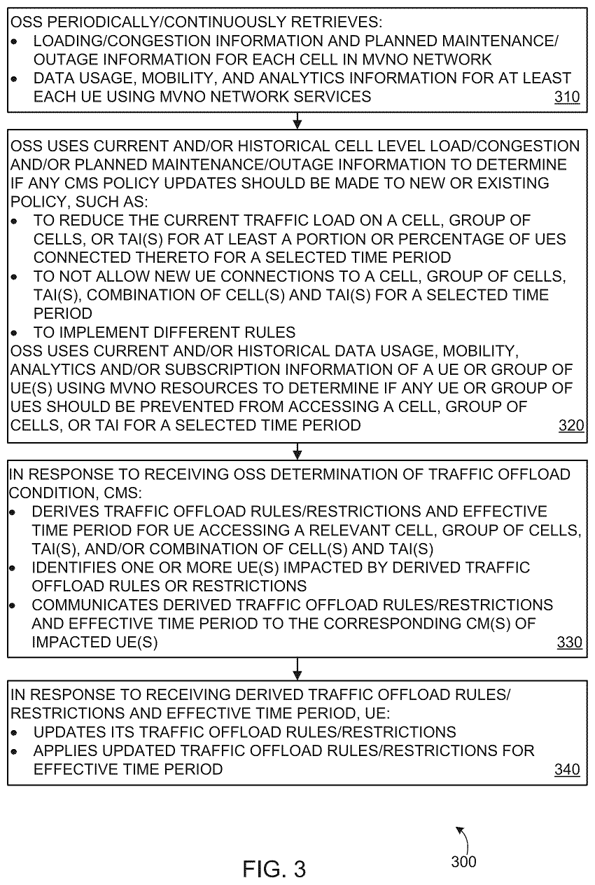

FIG. 3 depicts a flow diagram of a network controlled MNO to MVNO offloading method according to an embodiment. In these embodiments, the network is in control of traffic offloading decisions based on cell load/congestion information and/or data usage, nobility, analytics and subscription information of UE(s). These embodiments rely on the CMS 150 of a UE to derive traffic offload rules (restrictions) based on requests from OSS 190. These embodiments are pro-active in that they are intended to keep the load on MVNO small cells at a manageable level before facing any congestion.

At step 310, the OSS periodically/continuously retrieves: loading/congestion information, planned maintenance/outage information and the like for each cell in MVNO network; and data usage, mobility, and analytics information for UE using MVNO network services. That is, the OSS 190 (of the MVNO network) gets or collects cell load information for each cell in the MVNO network. The OSS has available to it planned maintenance/outage information for each cell in MVNO network. The OSS gets or collects data usage, mobility and analytics information of UEs using the MVNO network.

At step 320, the OSS 190 uses current and/or historical cell level load/congestion and/or planned maintenance/outage information to determine if any CMS policy updates should be made, such as: to reduce the current traffic load on a cell, group of cells (e.g., cells associated with one or more TAI) for at least a portion or percentage of UEs connected thereto for a selected time period; to not allow new UE connections to a cell or group of cells for a selected time period; and/or to implement new or different rules. The OSS may use current and/or historical data usage, mobility, analytics and/or subscription information of a UE or group of UE(s) using MVNO resources to determine if any UE or group of UEs should be prevented from accessing a cell, group of cells, TAI or TAIs, or combination of cell(s) and TAI(s) for a selected time period.

At step 330, in response to receiving an OSS determination indicative of a traffic offload condition/requirement, the CMS: derives traffic offload rules/restrictions and effective time period for UE accessing a relevant cell, group of cells, TAI(s), or combination of cell(s) and TAI(s); identifies one or more UE(s) impacted by derived traffic offload rules or restrictions; and communicates derived traffic offload rules/restrictions and their effective time periods to the corresponding CM(s) of impacted UE(s). The derived traffic offload rules are sent only to CM(s)/UE(s) where the UEs are in or likely to be in the provinces of the cells during the time period that the rules are effective and/or the specific UE(s) communicated by the OSS at step 330.

At step 340, in response to receiving derived traffic offload rules/restrictions and effective time period information, the receiving UE updates its traffic offload rules/restrictions, and applies the updated traffic offload rules/restrictions for the effective time period/duration.

In various embodiments, a first or default traffic offload policy such stated herein may comprise “use MVNO network for internet traffic when the UE is in MVNO network coverage unless the UE has to be connected to MNO network based on its radio network capabilities to carry certain other traffic types (e.g. IMS voice), which can only be supported by the MNO network.”

In various embodiments, the rules (restrictions) communicated by the CMS 150 to a CM 105-CM override the default rules in the cell(s)/TAI(s) where the rules (restrictions) are applicable.

In various embodiments, steps 310-330 may be triggered periodically or at any other time.

In various embodiments, the CMS 150 may override or remove any rule (restriction) that was previously communicated. Any rule (restriction) may be overwritten or removed even before expiry of the applicable effective duration.

In various embodiments, if there is a TAI level policy and a cell level policy that conflict (i.e., the cell belongs to the TAI but each has a different policy), the cell level policy overrides the TAI level policy for the overlapping cell.

In various embodiments, where the OSS 190 may request the CMS 150 to reduce current traffic load on a cell or group of cells, TAI or TAIs, or a combination of cell(s) and TAI(s) for a percentage of UEs connected thereto for a time period, the CMS 150 may reduce the load in the requested cells with an approximate to the requested percentage.

In various embodiments, if the CMS 150 has the location information of UEs at a requested granularity (e.g., cell level or TAI level), the CMS 150 may choose the number of UEs that may reflect the requested percentage reduction of load, and may send rules (restrictions) to the chosen CM(s)/UE(s). Sample rules (restrictions) for this scenario are depicted in Table 1 below.

TABLE 1

| | Location | Applicable start time | Applicable stop time |
|---|---|---|---|
| Location Identifier | type | <date1> <time1> | <date2> <time2> |
| <MCC> <MNC> <NR_cell_ID> | NCGI | 20210416-1700 | 20210416-1800 |
| <MCC> <MNC> | ECGI | 20210416-1700 | 20210416-1800 |
| <EUTRA_cell_ID> | | | |
| <MCC> <MNC> <NR_TAC> | NR TAI | 20210416-2300 | 20210417-0100 |
| <MCC> <MNC> | EUTRA | 20210416-2100 | 20210416-2130 |
| <EUTRA_TAC> | TAI | | |

In various embodiments, if the CMS 150 has the location information of UEs at TAI-level granularity, but the requested granularity from the OSS is at cell-level, the CMS 150 may need to send the rules (restrictions) to all CM(s)/UE(s) in the TAI of the cell for which load reduction was requested. Sample rules (restrictions) for this scenario are depicted in Table 2 below.

TABLE 2

| | Location | Applicable start time | Applicable stop time | Percentage |
|---|---|---|---|---|
| Location Identifier | type | <date1><time1> | <date2><time2> | offload |
| <MCC> <MNC> | NCGI | 20210416-1703 | 20210416-1723 | 20% |
| <NR_cell_ID> | | | | |
| <MCC> <MNC> | ECGI | 20210416-1700 | 20210416-1800 | 10% |
| <EUTRA_cell_ID> | | | | |

In various embodiments, if a CM/UE receives a rule (restriction) with a “percentage offload” field as in Table 2, the CM/UE will take the following actions in order to identify whether it should apply the rule (restriction): (1) If the CM/UE is in the coverage of the cell in the “location identifier” field, the CM/UE will generate a random integer between 1 and 100 with uniform distribution. If the generated random number is less than or equal to the value in “percentage offload” field, the rule will be applicable to the CM/UE. Otherwise, i.e., if the generated random number is greater than the value in “percentage offload” field, the rule will not be applicable to the CM/UE; and (2) If the CM/UE is not in the coverage of the cell in the “location identifier” field, the CM/UE will ignore this rule (restriction).

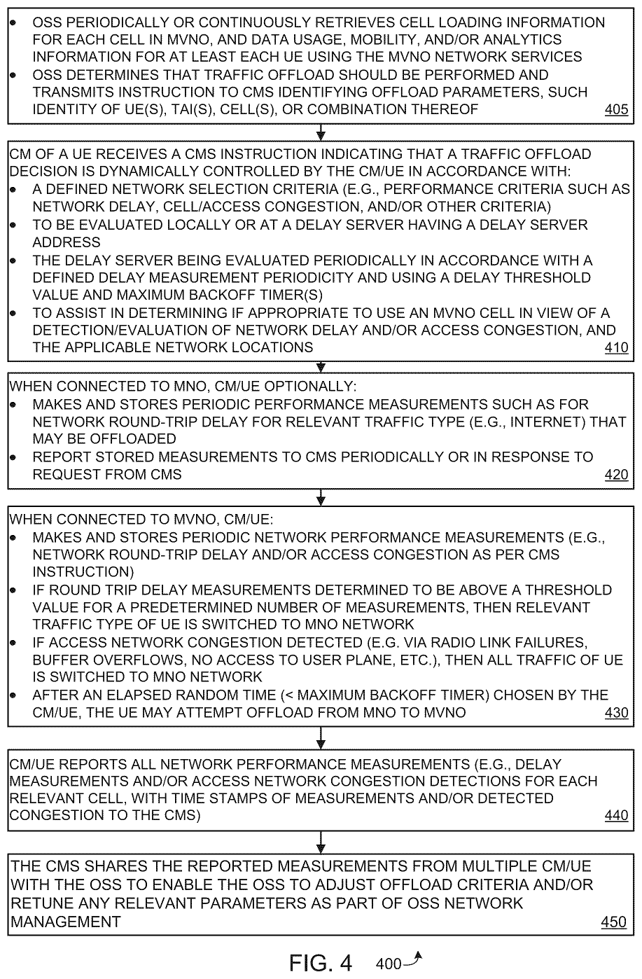

FIG. 4 depicts a flow diagram of a CM/UE-controlled MNO to MVNO offloading method according to an embodiment. In these embodiments, the CM/UE is in control of traffic offloading decisions based on network quality measurements made while the UE is connected to the MVNO small cell network. This method relies on the CM/UE to measure network delay, and/or to detect access (radio) congestion in serving MVNO small cell=and/or to use any other criteria which can be indicative of cell load or congestion; and then makes decision to stay on the MVNO small cell network or move to the MNO network.

At step 405, the OSS 190 periodically or continuously retrieves cell load information for each cell in the MVNO network, as well as data usage, mobility, and/or analytics information for UE using the MVNO network services. The OSS 190 may determine that a traffic offload should be performed and transmits a corresponding instruction to the CMS 150 identifying the offload parameters (e.g., that a CM/UE or a number of CM(s)/UE(s) or all CM(s)/UE(s) to have the control of the traffic offload decision in a cell or a TAI or some cells or some TAIs or a combination of cell(s) and TAI(s) or even the entire MVNO network).

At step 410, the CM 105-CM of each of a plurality of UE receives a CMS instruction indicating that a traffic offload decision is dynamically controlled by the CM/UE in accordance with a defined network selection criteria (e.g., performance related criteria such as network delay, cell/access congestion, and/or other performance related criteria), which selection criteria may be evaluated locally or at a delay server having a delay server address, wherein the delay server is evaluated periodically in accordance with a defined delay measurement periodicity and using a delay threshold value and maximum backoff timer(s), to assist in determining if it is appropriate to use an MVNO cell in view of a detection/evaluation of network delay and/or access congestion. That is, the CMS 150 instructs each CM 105-CM that the traffic offload decision is dynamically controlled by the CM/UE. It also provides the network selection criteria (network delay and/or access congestion), FQDN (Fully Qualified Domain Name) or IP address of the server to be used for delay measurement, periodicity of delay measurements, delay threshold value, and a maximum backoff timer(s) to reselect MVNO network in case of detection of network delay or access congestion, the applicable network location (e.g., cell(s), TAI(s) or whole network) and any other relevant parameters.

At optional step 420, when connected to the MNO network, each of the plurality of CM/UE is operable to make and store periodic measurements such as for network round-trip delay, access congestion and the like for a relevant traffic type (e.g., internet traffic) that may be offloaded, and to report the stored measurements to the CMS 150 periodically or in response to request from CMS 150. The round-trip delay may be measured by the CM 105-CM by sending a known size of packet(s) to a server set up by the operator for this purpose (i.e., the delay server). The server, as a response to the received packet(s), reflects the same packet back to the CM. The FQDN or IP address of the server can be shared by the CMS 150 in step 410, or it can be preconfigured in the CM.

At step 430, when connected to the MVNO network, each of the plurality of CM/UE makes and stores periodic performance measurements such as for network round-trip delay and/or access congestion as per the CMS instruction. If round trip delay measurements are determined to be above a threshold value for more than a predetermined number of measurements, then traffic of the relevant traffic type of one or more of the UEs is switched to the MNO network. If access network congestion is detected (e.g., via radio link failures, buffer overflows, no access to user plane, etc.), then all traffic of one or more of the UEs is switched to the MNO network. After the elapsing of a random time (less than maximum backoff timer) chosen by the CM/UE, each UE may attempt traffic offload from the MNO network to the MVNO network.

That is, while the UE is connected to the MVNO network, the CM 105-CM makes periodic measurements on network round-trip delay and/or access congestion. If the delay measurements are above the threshold value for a pre-configured number of times, the UE may switch the traffic back to the MNO network. Similarly, if the UE detects access network congestion (e.g., via radio link failures, buffer overflows, not possible access user plane, etc.), the UE switches back to the MNO network. After a random time (less than maximum backoff timer) chosen by the UE, the UE can choose the MVNO network again (if the UE is in the coverage of the MVNO network) to re-attempt traffic offload. The round-trip delay may be measured by the CM 105-CM transmitting a known size of packet(s) to the server set up by the operator for this purpose. The server, as a response to the received packet(s), reflects the same packet back to the CM 105-CM and the delay between transmit and receive times is noted.

At step 440, each CM/UE reports to the CMS 150 all network delay measurements and/or access network congestion detections for each cell with associated time stamp data indicative of when the measurements were made and/or the congestion is detected. That is, the CM 105-CM reports all network delay measurements and/or any access network congestion detections for each cell along with the relevant time stamps of when the measurements are made and/or the congestion is detected to the CMS 150. Such information can allow the operator to adjust offload criteria and/or retune any relevant parameters. The report for delay measurements may be sent periodically (preferably not lower than the periodicity of the delay measurements) in a consolidated form to the CMS 150. The CM 105-CM may also send the measurement reports after the UE switches the traffic to MNO network due to experienced delay or congestion in MVNO network. If an access network congestion is detected on MVNO network, the report may be sent over MNO network.

At step 450, the CMS 150 shares the reported measurements from the multiple CM/UE with the OSS 190 to enable the OSS 190 to adjust offload criteria and/or retune any relevant parameters as part of OSS network management functions. That is, the CMS 150 shares the reported measurements coming from various CMs/UEs to the OSS to take any necessary actions for network planning. The CMS 150 may initiate step 450 at any time, or as needed basis. Based on the report received from a CM 105-CM in step 440 and/or similar reports from other CMs 105-CM, the CMS 150 may initiate step 410 at any time if there is any need to adjust the traffic offload policy and any relevant parameters.

In various embodiments, if the UE has access to (i.e., is in the coverage of) the MNO network, the MVNO small cell network and a WiFi network, as per the default policy in the CM 105-CM of a UE, it may prioritize the WiFi network (over MVNO small cell network) for the traffic types to be offloaded from the MNO network.

As discussed herein, some of the embodiments provide for the offloading of UE traffic from a MNO network (first network) to a MVNO network (second network). Other embodiments provide for the offloading of UE traffic from a MNO network (first network) to a MVNO network (second network), where the UE is subscribed to a MVNO-x network (third network) and roaming with respect to the MVNO (second network). The MVNO and MVNO-x networks may be commonly owned or owned by different Operators. Thus, in various embodiments it is contemplated that one MVNO network (second network) may be in communication with another MVNO-x network (third network) so as to controllably share resources, manage respective MNO to MVNO offloads in both roaming and non-roaming situations, and perform other functions as contemplated herein.

The embodiments described above with respect to the various figures provide methods for identifying and communicating a dynamic traffic offload policy to UE(s) in dual-network deployment use case, including a network-controlled solution and a controlled solution. In the network-controlled solution, the network is in control of traffic offloading decisions based on cell load/congestion information and/or data usage, mobility, analytics and subscription information of UE(s). This method relies on the CMS (Connection Manager Server) to derive traffic offload rules (restrictions) based on requests from the OSS. The method is considered pro-active such that it strives to keep the load on MVNO small cells at a manageable level before facing any congestion. In the CM/UE-controlled solution, the CM/UE is in control of traffic offloading decisions based on network quality measurements made while the UE is connected to the MVNO small cell network. This method relies on the CM/UE to measure network delay and/or to detect access (radio) congestion in the MVNO small cell network and then makes a decision to stay on the MVNO small cell network or move to the MNO network. The MVNO may choose to use either the network-controlled solution or the CM/UE-controlled solution or both in their network. The MVNO may choose to switch the solution method used by a CM/UE at any time by communicating associated instructions from the CMS 150 to the CM 105-CM as per the embodiments described herein.

The above-described embodiments are generally discussed within the context of the offloading of some UE traffic from a MNO network (first network) to a MVNO network (second network).

The above-described embodiments may be modified for use with the MNO to MVNO offloading of UE traffic wherein the UE traffic is associated with the receiving MVNO or is roaming (i.e., associated with a different MVNO-x). Various embodiments contemplate that the first and second MVNOs (i.e., MVNO and MVNO-x) are each managed with similar load balancing and other goals such that offloading roaming or non-roaming UE traffic from an MNO is implemented in accordance with such mutually supporting goals, such as providing services to each other's subscribers in respective small cell networks. In particular, subscribers to either of the MVNO and MVNO-x networks may roam within the total footprint of the two networks including where offloaded from an MNO.

Various embodiments, facilitate dynamic traffic offload policy updates to the CMs/UEs of, illustratively, MVNO-x from an MNO while those CMs/UEs are roaming in the MVNO network.

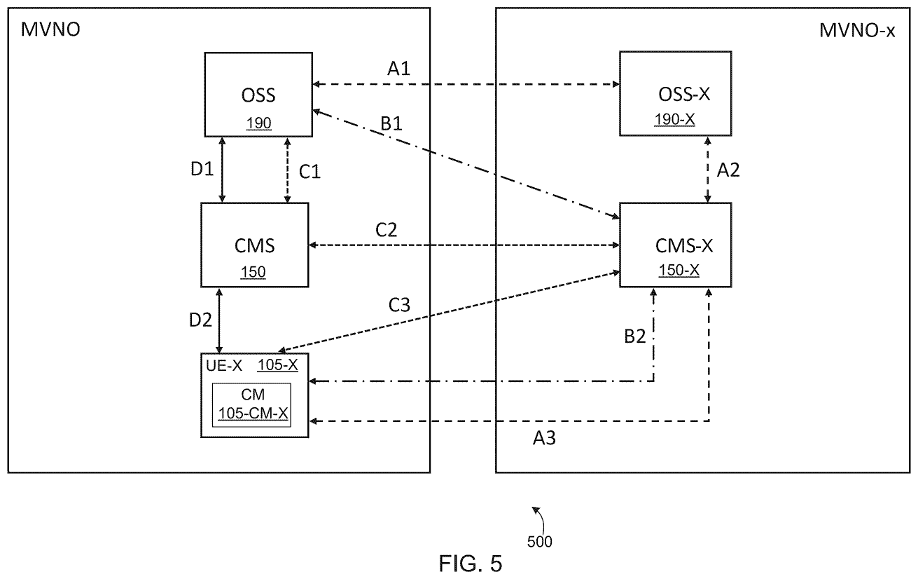

FIG. 5 graphically depicts MVNO to MVNO-x signaling useful in understanding various embodiments. Specifically, FIG. 5 depicts a system 500 comprising two cooperating MVNO networks, MVNO and MVNO-x, each associated with a respective OSS 190/190-x and CMS 150/150-x. As depicted in FIG. 5, a UE 105-x subscribed to MVNO-x and including a CM 105-CM-x is currently receiving network services from cells of an MNO network (not shown) proximate the MVNO network (a roaming partner to MVNO-x) and is to be offloaded from the MNO network to the MVNO network.

FIG. 5 graphically depicts signalling associated with the OSS 190 of the MVNO in determining that the UE 105-x is to be offloaded from the MNO to a small cell of the MVNO network. The signalling is associated with providing traffic policy updates to the CM/UE-x 105-x of MVNO-x while the UE-x 105-x is roaming in the MVNO network and may be performed in substantially the same manner as described above with respect to FIGS. 2-4, with additional signaling between OSS 190 and CM/UE-x 105-x supported by one of four signaling paths which may be used as agreed by MVNO and MVNO-x:
(A) OSS 190, OSS-x 190-x, CMS-x 150-x, and CM/UE-x 105-x;
(B) OSS 190, CMS-x 150-x, and CM/UE-x 105-x;
(C) OSS 190, CMS 150, CMS-x 150-x and CM/UE-x 105-x; and
(D) OSS 190, CMS 150, and CM/UE-x 105-x.
   Network-Controlled Offloading Methods with Respect to FIGS. 5 and 3.

A (A1-A3): The OSS 190 sends requests associated with the CM(s)/UE(s) of MVNO-x (i.e., CM/UE-x 105-x) to the OSS of MVNO-x (i.e., OSS-x 190-x), such as in step 320 of the method 300 of FIG. 3. The OSS-x 190-x subsequently performs step 320 with respect to the CMS of MVNO-x (i.e., CMS-x 150-x) serving to its impacted UE(s) (i.e., UE-x 105-x). Then, steps 330-340 are executed between the CMS-x 150-x and the CM/UE-x 105-x. This option assumes that the OSS 190 has connectivity to the OSS-x 190-x via A1, such as to enable communication therebetween of policy information, UE roaming information, and other information as discussed herein.

B (B1-B2): The OSS 190 sends similar requests associated with the CM/UE-x 105-x such as in step 320 of the method 300 of FIG. 3 to the CMS-x 150-x. Then steps 330-340 are executed between the CMS-x 150-x and the CM/UE-x 105-x. This option assumes that the OSS 190 has connectivity to the CMS-x 150-x via B1.

C (C1-C3): Upon receiving the requests from the OSS 190, the CMS 150 sends the policies associated with the CM/UE-x 105-x to the CMS-x 150-x. Then steps 330-340 are executed between the CMS-x 150-x and the CM/UE-x 105-x. This option assumes that the CMS 150 has connectivity to the CMS-x 150-x via C2.

D (D1-D2): Upon receiving the requests from the OSS 190 as per step 320, the CMS 150 sends the policies to the CM/UE-x 105-x as in step 330. Then step 340 is executed by the CM/UE-x 105-x. This option assumes that while the UE-x 105-x uses the MVNO network, the CM-x 105-x has performed registrations to the CMS 150; and the CMS 150 is allowed to provide policies directly to such CM-x 105-x while UE-x 105-x uses the MVNO network.

CM/UE Controlled Offloading Methods with Respect to FIGS. 5 and 4.

In various embodiments, where the MVNO allows its network to be used/shared by UEs of another MVNO (denoted herein as MVNO-x), having similar traffic offload interests from its (i.e., MVNO-x's) partner MNO network, and the OSS 190 may need to adjust the traffic load on a cell, or a group of cells, or a TAI, or some TAIs, or a combination of cell(s) and TAI(s) by initiating traffic offload policy updates to the CM(s)/UE(s) of MVNO-x (i.e., CM/UE-x 105-x) connected thereto by using the CM/UE-controlled offloading method. In this case one of the following signaling communication options/paths from the MVNO network to the CM/UE-x 105-x can be used:

A (A1-A3): The OSS 190 sends requests associated with the CM/UE-x 105-x, such as in step 405 of the method 400 of FIG. 4, to the OSS-x 190-x. The OSS-x 190-x subsequently performs step 405 with respect to the CMS-x 150-x serving to its impacted UE(s) (i.e., UE-x 105-x). Then, steps 410, 430, 440, 450 are executed between the CMS-x 150-x and the CM/UE-x 105-x. This option assumes that the OSS 190 has connectivity to the OSS-x 190-x via A1.

B (B1-B2): The OSS 190 sends similar requests associated with the CM(s)/UE(s) of MVNO-x, such as in step 405 of the method 400 of FIG. 4, to the CMS-x 150-x. Then steps 410, 430, 440, 450 are executed between the CMS-x 150-x and the CM/UE-x 105-x. This option assumes that the OSS 190 has connectivity to the CMS-x 150-x via B1.

C (C1-C3): Upon receiving the requests from the OSS 190, the CMS 150 sends the policies associated with the CM/UE-x 105-x to the CMS 150-x of MVNO-x. Then steps 410, 430, 440, 450 are executed between the CMS 150-x of MVNO-x and the CM/UE-x 105-x. This option assumes that the CMS 150 has connectivity to the CMS-x 150-x via C2.

D (D1-D2): Upon receiving the requests from the OSS 190 as per step 405, the CMS 150 sends the policies to the CM/UE-x 105-x as per step 410. Then step 430, 440, 450 are executed by the CM/UE-x 105-x, the CMS 150 and the OSS 190. This option assumes that while the UE(s) use the MVNO network, the CM-x 105-x has performed registrations to the CMS 150; and the CMS 150 is allowed to provide policies directly to such CM-x 105-x while UE-x 105-x uses the MVNO network.

The embodiments described above with respect to the various figures provide methods for identifying and communicating a dynamic traffic offload policy to UE(s) in dual-network deployment use case, including a network-controlled solution and a CM/UE controlled solution. In the network-controlled solution, the network is in control of traffic offloading decisions based on cell load/congestion information and/or data usage, mobility, analytics and subscription information of UE(s). This method relies on the CMS (Connection Manager Server) to derive traffic offload rules (restrictions) based on requests from the OSS. The method is considered pro-active such that it strives to keep the load on MVNO small cells at a manageable level before facing any congestion. In the CM/UE-controlled solution, the CM/UE is in control of traffic offloading decisions based on network quality measurements made while the UE is connected to the MVNO small cell network. This method relies on the CM/UE to measure network delay and/or to detect access (radio) congestion in the MVNO small cell network and then makes a decision to stay on the MVNO small cell network or move to the MNO network. The MVNO may choose to use either the network-controlled solution or the CM/UE controlled solution or both in their network. The MVNO may choose to switch the solution method used by a CM/UE at any time by communicating associated instructions from the CMS 150 to the CM 105-CM as per the embodiments described above.

Various embodiments discussed herein enable a number of new use cases and as well as improvements to existing use cases, including the following:

Various embodiments enable a subscriber of a partner MVNO (e.g., MVNO-x) to avail themselves of the services of the partner MVNO while under its coverage to offload data traffic in accordance with various traffic related information (e.g., load, capacity and other metrics), wherein an exchange of information from the MVNO OSS of would-be serving MVNO to OSS-x further to CMS-x to CM/UE-x of subscribed MVNO-x in a network controlled manner, as noted with respect to FIG. 5 and path A1-A2-A3 with respect to a network-controlled embodiment).

Various embodiments enable a subscriber of partner MVNO (MVNO-x) to avail the services of another visiting MVNO while under its coverage to offload data traffic using the necessary insights and exchange of information from OSS of would be serving MVNO to OSS-x further to CMS-x to CM/UE-x of subscribed MVNO-x as desired by the CM/UE-x based on operator policies and current network insights received, as noted with respect to FIG. 5 and path A1-A2-A3 with respect to a CM/UE-controlled embodiment.

Various embodiments enable a subscriber of partner MVNO (MVNO-x) to avail the services of another visiting MVNO while under its coverage to offload data traffic using the necessary insights and exchange of information from OSS of would be serving MVNO to CMS-x to CM/UE-x of subscribed MVNO-x in a network controlled manner, as noted with respect to FIG. 5 and path B1-B2 with respect to a network-controlled embodiment.

Various embodiments enable a subscriber of partner MVNO (MVNO-x) to avail the services of another visiting MVNO while under its coverage to offload data traffic using the necessary insights and exchange of information from OSS of would be serving MVNO to CMS-x to CM/UE-x of subscribed MVNO-x as desired by the CM/UE-x based on operator policies and current network insights received, as noted with respect to FIG. 5 and path B1-B2 with respect to a CM/UE-controlled embodiment.

Various embodiments enable a subscriber of partner MVNO (MVNO-x) to avail the services of another visiting MVNO while under its coverage to offload data traffic using the necessary insights and exchange of information from OSS to CMS of would be serving MVNO to CMS-x to CM/UE-x of subscribed MVNO-x in a network controlled manner, as noted with respect to FIG. 5 and path C1-C2-C3 with respect to a network-controlled embodiment.

Various embodiments enable a subscriber of partner MVNO (MVNO-x) to avail the services of another visiting MVNO while under its coverage to offload data traffic using the necessary insights and exchange of information from OSS to CMS of would be serving MVNO to CMS-x to CM/UE-x of subscribed MVNO as desired by the CM/UE-x based on operator policies and current network insights received, as noted with respect to FIG. 5 and path C1-C2-C3 with respect to a CM/UE-controlled embodiment.

Various embodiments enable a subscriber of partner MVNO (MVNO-x) to avail the services of another visiting MVNO while under its coverage to offload data traffic using the necessary insights and exchange of information from OSS to CMS of would be serving MVNO to CM/UE-x of subscribed MVNO-x in a network controlled manner, as noted with respect to FIG. 5 and path D1-D2 with respect to a network-controlled embodiment.

Various embodiments enable a subscriber of partner MVNO (MVNO-x) to avail the services of another visiting MVNO while under its coverage to offload data traffic using the necessary insights and exchange of information from OSS to CMS of would be serving MVNO to CM/UE-x of subscribed MVNO as desired by the CM/UE-x based on operator policies and current network insights received, as noted with respect to FIG. 5 and path D1-D2 with respect to a CM/UE-controlled embodiment.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. It will be appreciated that the term “or” as used herein refers to a non-exclusive “or,” unless otherwise indicated (e.g., use of “or else” or “or in the alternative”).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A method of managing Dual SIM Dual Standby (DSDS) user equipment (UE) configured to communicate with each of a first and second network, comprising:
at a connection manager server (CMS) of the second network, receiving a traffic offload policy associated with an identified cell or group of cells of the second network;
at the CMS, determining each of at least one UE proximate any of the identified cell or group of cells of the second network; and
transmitting traffic offload rules toward the determined each of at least one UE proximate any of the identified cell or group of cells of the second network;
wherein each traffic offload rule is configured to cause a receiving UE to offload to a proximate identified cell in the second network for an effective time period an amount of traffic defined by the traffic offload rule.

2. The method of claim 1, wherein the traffic offload policy is determined in response at least one of second network cell loading information, second network planned maintenance information, second network planned outage information, UE data usage information, UE mobility information, and UE analytics information collected for UEs using second network services.

3. The method of claim 2, wherein the second network cell loading information, second network planned maintenance information, second network planned outage information, UE data usage information, UE mobility information, and UE analytics information is used by an Operation Support System (OSS) associated with the second network to determine the traffic offload policy.

4. The method of claim 3, wherein the traffic offload policy comprises a network-controlled traffic offload policy.

5. The method of claim 3, wherein the traffic offload policy comprises a UE connection manager (CM/UE) controlled traffic offload policy.

6. The method of claim 1, wherein the traffic offload policy defines whether a UE or group of UEs are to be prevented from accessing a cell or group of cells for an effective time period.

7. The method of claim 1, wherein the determined at least one UE comprises UE impacted by the traffic offload policy.

8. The method of claim 1, wherein the group of cells comprises cells associated with at least one Tracking Area Identity (TAI).

9. The method of claim 1, wherein at least one traffic offload rule comprises an instruction configured to cause a receiving UE to determine a traffic offload decision.

10. The method of claim 9, wherein the UE configured to determine a traffic offload decision comprises UE determined by the CMS to be associated with a defined cell or group of cells.

11. The method of claim 10, wherein the defined cell or group of cells of the second network is associated with a second network performance measurement below a threshold level.

12. The method of claim 11, wherein the second network performance measurement comprises at least one of a network delay measurement and a network congestion measurement.

13. The method of claim 12, further comprising transmitting the network performance measurements toward the CMS.

14. The method of claim 12, further comprising transmitting the network performance measurements toward an Operation Support System (OSS), the transmitted network performance measurements being configured to cause the OSS to adjust criteria within the traffic offload policy.

15. The method of claim 1, wherein the traffic offload rule is further configured to cause a receiving UE to reconnect to a first network cell in response to the receiving UE detecting congestion at a presently-connected second network cell above a threshold level.

16. The method of claim 1, wherein the first network comprises a mobile network operator (MNO) network, the second network comprises a mobile virtual network operator (MVNO) network, and a default traffic offload policy is configured to cause an offloading from a MNO network cell to a MVNO network cell of UE traffic.

17. The method of claim 16, wherein the UE comprises a UE-x associated with a third network comprising a different MVNO-x, and the traffic offload policy is further configured to cause an offloading from a MNO network cell to a MVNO network cell of UE-x traffic.

18. The method of claim 16, wherein an Operation Support System (OSS) of the second network MVNO communicates with the UE-x of the third network MVNO-x via an OSS-x and CMS-x of the third network MVNO-x.

19. The method of claim 16, wherein an Operation Support System (OSS) of the MVNO network communicates with the UE-x of the MVNO-x network via a CMS-x of the MVNO-x network.

20. The method of claim 16, wherein an Operation Support System (OSS) of the MVNO network communicates with the UE-x of the MVNO-x network via a CMS of the MVNO network and a CMS-x of the MVNO-x network.

21. The method of claim 16, wherein an Operation Support System (OSS) of the MVNO network communicates with the UE-x of the MVNO-x network via a CMS of the MVNO network.

22. Apparatus for managing Dual SIM Dual Standby (DSDS) user equipment (UE) configured to communicate with each of a first and second network, comprising:
a connection manager server (CMS) configured to communicate with UE subscribed to the second network, to receive a traffic offload policy associated with an identified cell or group of cells of the second network, to determine for each of at least one UE proximate any of the identified cell or group of cells of the second network a respective traffic offload rule, and to transmit the determined traffic offload rules toward the respective UE;
wherein each traffic offload rule is configured to cause a receiving UE to offload to a proximate identified cell in the second network for an effective time period an amount of traffic defined by the traffic offload rule.

23. Computer-readable storage hardware having instructions stored thereon, the instructions, when carried out by computer processor hardware, cause the computer processor hardware to perform a method of managing Dual SIM Dual Standby (DSDS) user equipment (UE) configured to communicate with each of a first and second network, the method comprising:
at a connection manager server (CMS) of the second network, receiving a traffic offload policy associated with an identified cell or group of cells of the second network;
at the CMS, determining each of at least one UE proximate any of the identified cell or group of cells of the second network; and
transmitting traffic offload rules toward the determined each of at least one UE proximate any of the identified cell or group of cells of the second network;
wherein each traffic offload rule is configured to cause a receiving UE to offload to a proximate identified cell in the second network for an effective time period an amount of traffic defined by the traffic offload rule.
